(19) United States
(12) Patent Application Publication
(10) Pub. No.: US 2005/0246235 A1
(43) Pub. Date: Nov. 3, 2005

(54) Voice enabled interactive on-line auction system

(76) Inventors: Matthew Wilczynski, Playa del Rey, CA (US); Michael W. Birkhead, Copperopolis, CA (US); Mark W. Birkhead, San Diego, CA (US)

Correspondence Address: Mark W. Birkhead, 3830 Valley Centre, 705-345, San Diego, CA, 92130, US

(21) Appl. No.: 10/693,386

(22) Filed: Oct. 27, 2003

(51) Int. Cl. G06F 17/60

(52) U.S. Cl. 705/26

(57) ABSTRACT

A voice enabled interactive (i.e., automatic) on-line auction system and method for converting and transmitting on-line auction events into real time, dynamically generated interactive speech and voice recognition responses for delivery to telephone and mobile devices of a user. Files and documents are processed through speech recognition and text-to-speech systems for converting content, speech and audio into generated voice instructions. The documents contain software developed instructions that generate and process speech recognition responses and text to speech transmissions that are capable of being transported between users and the interactive auction system via a mobile device or telephone of the user in an interactive manner in order to create, transmit, receive and modify on-line auction events, auction information, and member profile information for the purposes of processing and transacting the on-line auction events.

A compact disc marked COMPUTER PROGRAM LISTING APPENDIX is attached hereto to provide a computer program listing in the Java language as one example for implementing in software the application system 130 so as to communicate with the on-line auction system 140 and interact with the telephony/voice system 120 of FIG. 1.

### BACKGROUND OF THE INVENTION

1. Field of the Invention

The present invention relates to a voice enabled automated, or on-line, auction system. More specifically, the present invention relates to a system and method for converting on-line auction event information into and from interactive voice responses and speech transmissions for auction member interaction.

2. Background Art

Prior to the introduction of the Internet, most auctions occurred at a predetermined fixed location where sellers would make certain items available for sale to the highest bidder. Auctions are generally classified as private, business-to-business, or open to the general public, including specific subgroups.

Automated auctions have played a key role in the evolution of free commerce throughout the world. Until less than ten years ago, automated auctions were largely unknown. The establishment of electronic commerce has introduced new methods for accessing and interacting with auctions, specifically auction event information. Generally, there are three models for accessing and interacting with automated auction information: Internet, telephone and mobile data devices.

Automated auctions were developed as a result of utilizing the Internet as the primary means for broadcasting and receiving auction event information as well as enabling a majority of the interactions with and between auction buyers and sellers. Members use the Internet to register with an automated auction service, such as eBay, and to create user profiles containing the auction items members wish to buy or sell.

Under the typical seller model, the auction service can notify the seller when an auction event occurs. An auction event is usually defined as an action or transaction having occurred that changes or modifies, in any manner, the content of a member's profile. Specific examples of an automated auction event would occur when a lot or item contained in the seller's profile is sold, a lot or item contained in the seller's profile receives a bid that is higher than a previous high bid, a lot or item contained in the seller's profile is within a time prior to a predetermined expiration time, and a lot or item contained in the seller's profile failed to sell upon expiration of the auction time.

Additionally, a seller may initiate a connection with the auction service in order to inquire about the current status of an item or items contained in the seller's profile. Further, a seller may connect to the auction service to add, delete and modify items contained in the seller's profile. The result of any of these events will trigger an event notice that can immediately be transmitted to the member, traditionally through email notification.

Under the typical buyer model, the auction service can notify the buyer when an auction event occurs. An auction event is usually defined as an action or transaction having occurred that changes or modifies, in any manner, the content of a member's profile. Specific examples of when an automated auction event notice would be sent is if the buyer has been outbid for a lot or item contained in the buyer's profile, a lot or item contained in the buyer's profile is within a time prior to a predetermined expiration time, a lot or item contained in the buyer's profile was entered into the auction service and matched to a list of items of interest to the buyer contained in the buyers' profile. The result of these events will trigger an event notice that can immediately be transmitted to the member, traditionally through email notification.

A buyer may also initiate a connection with the auction service in order to inquire about the current status of an item or items contained in the buyer's profile. Further, a buyer may connect to the auction service to add, delete and modify items contained in the buyer's profile. The result of these events will trigger an event notice that can immediately be transmitted to the member, traditionally through email notification.

At present, automated auction event notifications can only be transmitted through protocols that require a PC, client-server, or browser compliant device that is capable of receiving and/or transmitting http protocol based on-line event notifications. Access to automated auction event information is nearly always accomplished by an auction member using a PC to access the auction service via the Internet. However, there are many limitations that are imposed upon automated auction members by making automated auction event information available only by accessing the Internet through a PC or wireless device configured with the necessary software to view and interact with automated auction event information and content. If an auction member cannot gain access to a PC, he cannot access the auction event notification. The end result in many instances is that the bidder suffers an economic loss because of the inability to access the Internet and participate in the auction until after the final bid had already been submitted and countered.

Due to the limitations of current technology, in order for an auction member to have unlimited access to the auction service for the duration of an auction wherein the member is a participant, the member would be required to have constant access to or carry on his person a PC with Internet data access. Such a PC must be capable of the same coverage of data reception and transmission as those associated with wireless and terrestrial based telephone communication systems. The required PC would also need to roam from one wireless and cellular coverage area to another without the requirement of being reconfigured across individual networks to gain access to the Internet.

The present on-line auction model is not feasible due to the many practical technological limitations of modem IP, terrestrial and wireless networks, geographical registration requirements, security and access controls and transportability, whereby to prevent real-time access to auction event information. While wireless connectivity is pervasive throughout the world, transmission of protocols capable of carrying Internet content and http-based packets is not available in many areas. Additionally, many individuals will not adopt mobile phones as Internet browsers due to issues regarding the size and functionality of mobile phones and devices.

Computers are not sufficiently portable to be transported on one's person for any reasonable length of time. Mobile devices have not attained universal adoption in the market and suffer from extensive usability and feature set limitations. Separate subscriptions are required for each category of device connectivity, making using multiple wireless devices economically unsound. Most mobile device services are not currently configured to share a wireless account between a wireless telephony device and a mobile data device. Consequently, there is not an effective solution available to automated auction users that allows for pervasive interaction with auction event information in a real-time environment without extensive additional hardware and third-party wireless data service expenses.

Automated auction members want access to automated auction event information at all times. Auction members also want to have auction event information available to them in a format that is easy access, simple to use and available nearly anywhere in the world by means of a readily available telephone device. Accordingly, what is required is a system wherein automated auction members can interact with auction event information in real time though terrestrial based telephones, cellular phones, satellite phones and voice enabled mobile devices at anytime across any supporting wireless or terrestrial based telephone network.

### SUMMARY OF THE INVENTION

In general terms, disclosed herein is a voice enabled interactive on-line auction system and method that enables an auction member to receive and transmit real-time auction event information and commands through speech recognition and voice enabled systems. The voice enabled on-line auction system permits the auction member to interact with auction event information by means of a telephone. The nature of the interaction may involve the reception and transmission of queries and responses generated by the member and an existing auction service during the lifecycle of an on-line auction that includes voice responses or other human understandable and generated audio data formats.

These and other needs are fulfilled by the voice enabled on-line auction system disclosed herein, whereby a member of an on-line auction service can interact in real-time with auction events using a telephone to interface with auction event information conversion systems capable of transforming auction event information into and from interactive voice responses. The conversion system further allows on-line auction buyers and sellers the ability to access member profile information as well as the ability to search and browse on-line auction inventory using a telephone.

### BRIEF DESCRIPTION OF THE DRAWINGS

FIG. 1 is a block diagram illustrating the system and subsystem level elements of the voice enabled interactive on-line auction system of this invention;

FIG. 2 is a flow chart illustrating a main menu and auction interaction types offered by a voice enabled automated auction service;

FIG. 3 is an illustration of automated auction content and examples of action events;

FIG. 4 is a flow chart illustrating the process of an inbound (user initiated) interaction with auction events and/or objects offered by the voice-enabled, automated auction service;

FIG. 5 is a flow chart illustrating the process of outbound (system initiated) interaction with auction events generated by the auction service and received by a telephone device of a user;

FIG. 6 is a flow chart illustrating the process of an inbound (user initiated) interaction with the voice enabled automated auction service;

FIG. 7 is a flow chart illustrating the process of an outbound (system initiated) interaction with the voice enabled automated auction service;

FIG. 8 is a flow chart illustrating the normal cycle of data and control to and from the user and the voice enabled interactive on-line auction system of FIG. 1.

### DETAILED DESCRIPTION

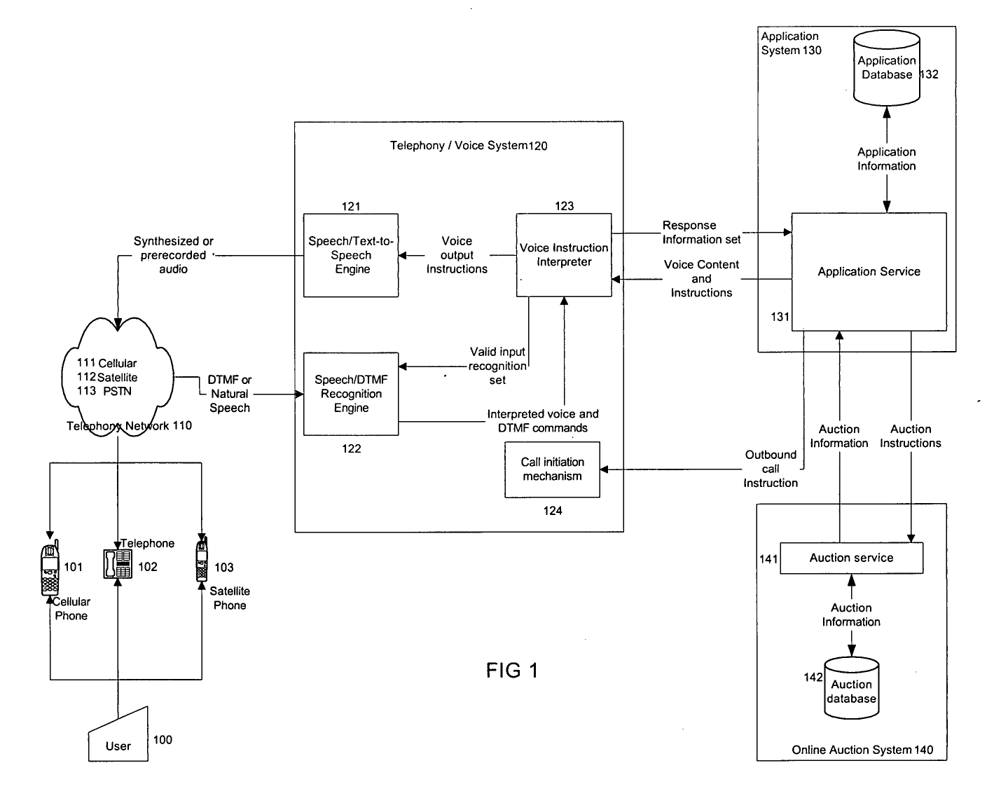

FIG. 1 of the drawings shows a block diagram that is representative of an automated interactive on-line auction system having interactive speech and voice recognition capabilities to enable real time user participation from telephone and mobile devices. The auction system of FIG. 1 is adapted to convert on-line content and other information containing on-line auction events and notification into interactive voice responses that are accessible to auction users by means of a terrestrial telephone system or mobile device such as, for example, a wireless phone, PDA, or other device that is capable of such interaction.

More particularly, the on-line auction system of FIG. 1 includes a telephony/voice system 120. The telephony/voice system 120 is responsible for making the connection to an outside telephony network 110 that is capable of being interfaced with a terrestrial or mobile telephone system of a user 100. That is, system 120 must be capable of accepting inbound telephone calls from an outside telephony device as well as initiating outbound calls to the outside telephony device. System 120 must also be able to receive and understand commands and information that is received from an outside application system 130 in a manner that will be explained in greater detail hereinafter.

The telephony/voice system 120 includes a voice instruction interpreter 123 that is capable of receiving and understanding voice content and instructions in an electronic format that are indicative of input and output prompts that the telephony/voice system 120 will hear and provide. By way of an example, the voice instruction interpreter 123 may be a VXML browser that understands VXML (voice extensive markup language).

The telephony/voice system 120 also includes a speech/text-to-speech engine 121 that is capable of converting the voice content and instructions (most commonly in the form of text) into human understandable speech and other audio to be output from the telephony/voice system 120.

In addition, the telephony/voice system 120 includes a speech/DTMF recognition engine 122 that is interfaced with the voice instruction interpreter 123. The speech/DTMF recognition engine 122 is capable of receiving and understanding speech and DTMF tones. Depending upon a predetermined grammar provided by voice instruction interpreter 123, the recognition engine 122 is able to match the incoming speech or DTMF tones generated by a user.

Lastly, telephony/voice system 120 also includes a call initiation mechanism 124 that is capable of receiving and understanding instructions to cause the system 120 to initiate an outbound telephone call to a user. The call initiation mechanism 124 is typically given a phone number to access and a link to the outside application system 130 at which a communication will begin once a telephone call has been successfully completed.

Its simplest form, the voice instruction interpreter 123 of the telephony/voice system 120 receives voice information and instructions by which to indicate the output of the system 120, the input for which the system 120 should be listening, an order of interaction, and further actions to be taken depending upon the occurrence of certain predetermined events. The voice instruction interpreter 123 provides the speech/text-to-speech engine 121 with voice output instructions, typically in the form of text or audio files, to be output from system 120 to a telephony system. The voice instruction interpreter 123 also provides the speech/DTMF recognition engine 122 with an input recognition set, commonly in the form of a grammar, to identify those speech patterns to which engine 122 should be responsive. Depending upon whether engine 122 receives information that is understood, corresponding information is relayed to the voice instruction interpreter 123 in the form of a subset of the grammar with which engine 122 was provided. Such information may also indicate an error condition. The voice instruction interpreter 123, speech/text-to-speech engine 121, speech/DTMF recognition engine 122 and call initiation mechanism 124 interact with one another and systems outside the telephony/voice system 120 to manage the telephony portion of the interaction between the user and an on-line auction system 140 by means of understanding human speech and DTMF key activations as well as the generation of output speech and other audio signals.

FIG. 1 also shows an application system 130 interconnected to the telephony/voice system 120. Application system 130 is responsible for managing and brokering the interface between telephony/voice system 120 and the on-line auction system 140. In certain cases, it may be possible to eliminate the application system 130 entirely. That is to say, it is possible for the auction system 140 to provide output instructions directly to and receive instructions from the telephony/voice system 120. Nevertheless, some separate and intermediate component will still be required between on-line auction system 140 and telephony/voice system 120 that is capable of interacting with users.

The application system 130 includes an application service 131 which is capable of transmitting and receiving instructions and information to and from the telephony/voice system 120. Such information would include, but is not limited to, outbound call initiation instructions, VXML to control the interaction with a user, hang-up instructions, etc. The application service 131 is also responsible for transmitting and receiving instructions and information to and from the on-line auction system 140. Such information would not be related to voice enabled user interaction instructions but would apply to automated auction specific information. For example only, the application service 131 would handle information provided by the auction system 140 indicating that a specific user was outbid for a specific auction item or the time remaining during which a specific item will be auctioned.

The application system 130 also includes an application database 132. Application database 132 is responsible for the delivery and persistence of application information to and from the application service 131. Such application information can include user profile information, cached auction item information, and the like.

The majority of the tasks performed by the application system 130 is completed by the application service 131. At the highest level, application service 131 is responsible for the translation of on-line auction specific information and commands into telephony/voice specific information and commands and visa-versa. The application service 131 enables the flow of information between the voice/telephony system 120 and the auction system 140.

FIG. 1 also shows the on-line auction system 140 interfaced with the application system 130. The on-line auction system 140 is responsible for auction management, auction member management, auction specific information, etc. The auction system 140 must be capable of communicating with the application system 130 of FIG. 1 through a suitable application programming interface that is preferably auction specific. The on-line auction system 140 includes an auction service 141. The auction service 141 is responsible for the management of the on-line auctions, auctions users, auction information, item information, auction notifications, and the like. Such an auction service 141 is common to conventional on-line auctions.

The on-line auction system 140 also includes an auction database 142. Auction database 142 is responsible for the delivery and persistence of auction information to and from the auction service 141. Such auction information can include user profile information, auction item information, etc.

The majority of the tasks performed by the on-line auction system 140 is completed by the auction service 141. At the highest level, the auction service 141 is responsible for making the auction automated. Auction service 141 must be capable of performing all of the services and actions that are common to a conventional on-line auction.

A user 100 communicates with the telephony/voice system 120 by way of a telephony network 110. Telecommunications networks like that represented by reference numeral 110 are well known and, therefore, will not be described in detail herein. In general, however, the telephony network 110 is responsible for a connection between the user's telephony device and the telephony/voice system 120. By way of example, the telephony network 110 may include some or all of a cellular or mobile telephone network 111, a satellite telephone network 112, and/or a public switched telephony network (PSTN) 113.

A user 100 wishing to participate in an on-line auction communicates with the telephony/voice system 120 by way of the telephony network 110 and a suitable telephone device. Such a user activated telephone device by which to enable the user 100 to access the on-line auction system 140 may include, but is not limited to, a mobile or cellular phone 101, a terrestrial telephone 102, or a satellite phone 103.

Although the telephony/voice system 120, the application system 130 and the on-line auction system 140 of FIG. 1 are illustrated as separate systems, these systems are not necessarily limited by physical hardware boundaries. That is to say, each system could reside on and be run by the same computer. Moreover, the software used to control such a computer in the voice enabled automated on-line auction system of this invention could be written as a single monolithic program. On the other hand, the systems 120, 130 and 140 of the voice enabled automated on-line auction system of FIG. 1 are not required to be located on a single machine. By way of example, the auction database 142 of the on-line auction system 140 could be distributed across a series of interlinked machines which span the globe. Therefore, it is to be understood that the components, systems and subsystems of the voice enabled interactive on-line auction system of FIG. 1 are illustrated merely to denote the most logical boundaries so that the construction, organization and interconnection may be more easily understood.

In this same regard, it should also be understood that the directional arrows illustrated between the systems 120, 130 and 140 denote the most logical information flow path. However, the precise means for generating the information flow as well as the corresponding flow paths can be accomplished in different ways. For example, one directional arrow in FIG. 1 illustrates that auction information flows from the auction service 141 of auction system 140 to the application service 131 of application system 130. The auction service 141 can send auction information to a listening port on the application service 131 without ever having been prompted for said information (i.e., often referred to as a push by the auction service to the application service), or the application service 131 can request certain information from the auction service 141. Such requested information should be returned to the application service 131 in the reply generated by the auction service 141 (i.e., often referred to as a pull by the application service from the auction service).

What is more, other devices can be included in FIG. 1 to initiate information flow. For example, the delivery of information denoting that a particular user was outbid for a particular item can be accomplished in different ways. In a first case, a user 100 that is connected to the application system 130 through the telephony/voice system 120 could request, by means of his phone and voice, information whether he has been outbid on any auction items. This request would be translated and ultimately transferred to the application system 130 which eventually causes the application service 131 to request from the auction service 141 information to identify whether the user 100 has been outbid. In the alternative, a timing mechanism could expire within the application service 131 at which time the application service will request from the auction service 141 suitable information to identify whether the user 100 has been outbid. As an additional alternative, upon determining that the user 100 was outbid, the auction service 141 will push the information to the application service 131.

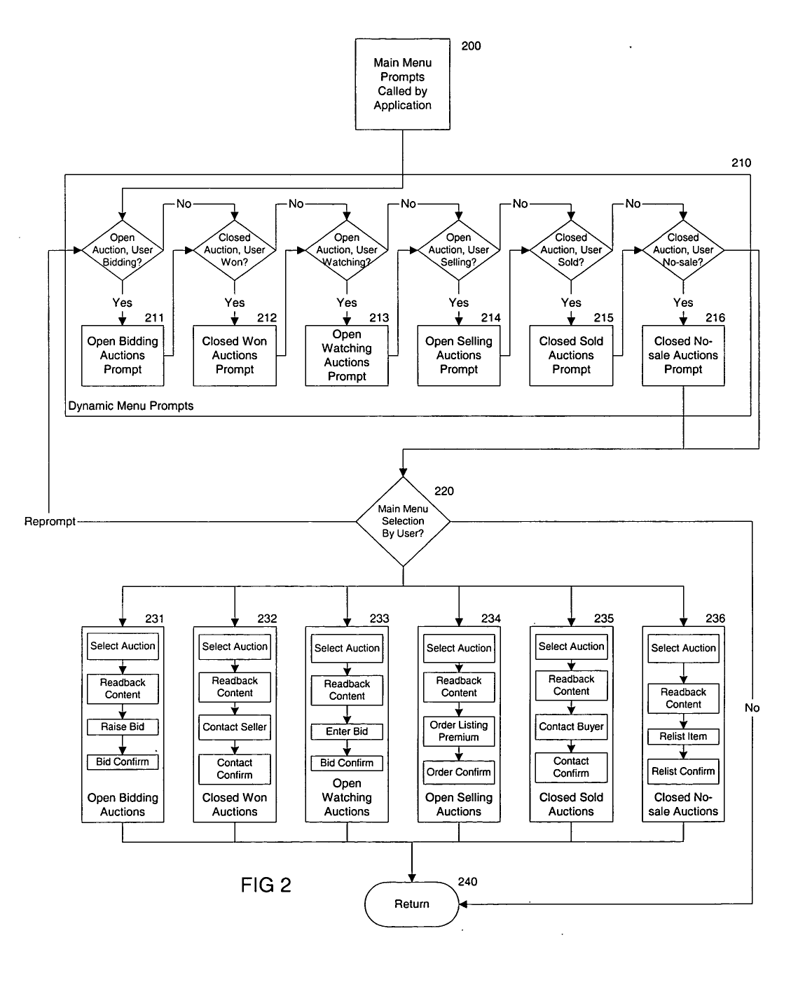

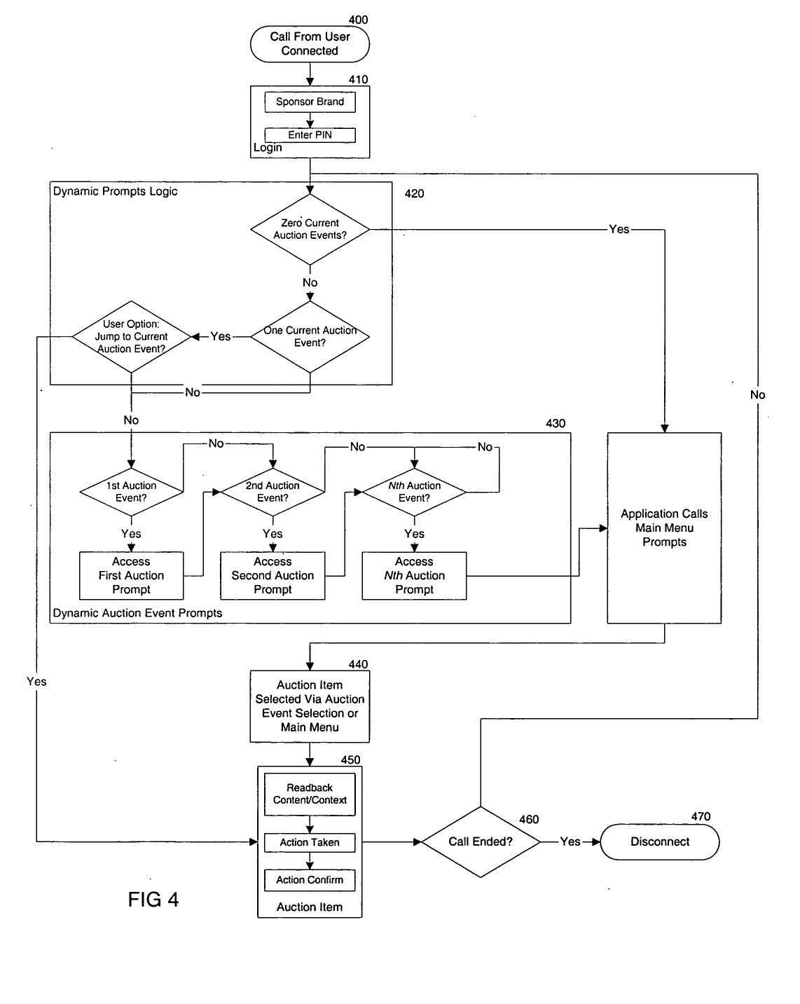

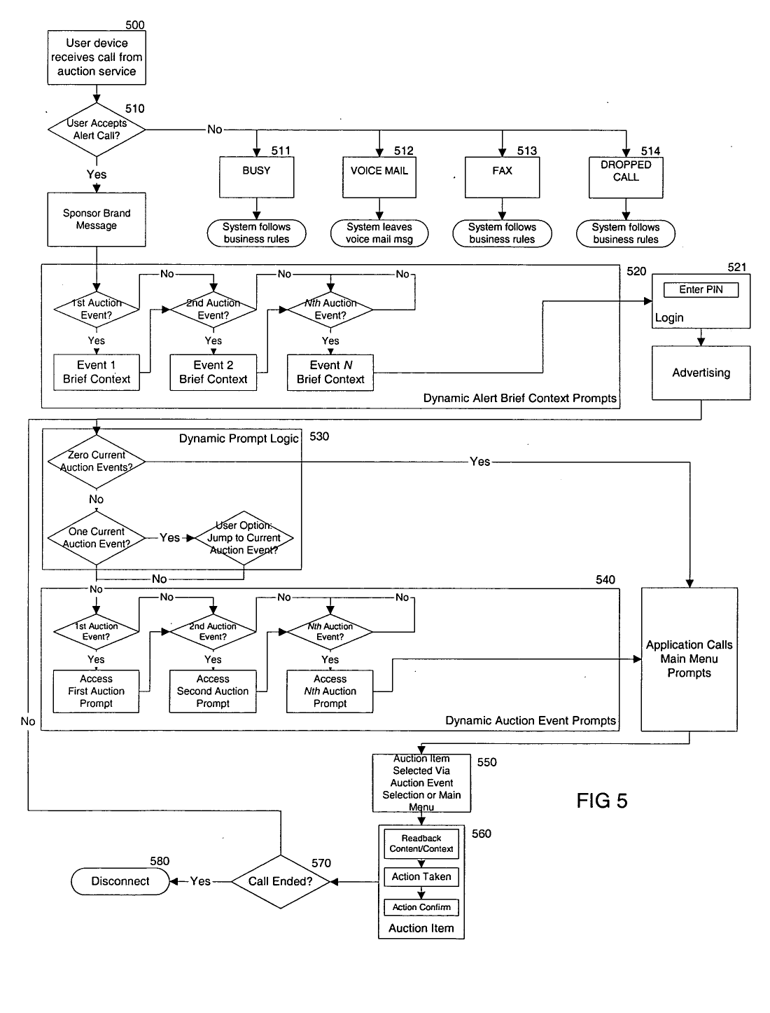

FIG. 2 of the drawings illustrates a main menu for the voice enabled interactive on-line auction system of FIG. 1 and the auction interaction types that are offered therein. The main menu of FIG. 2 is called up by the voice application during step 200 for presentation to the user either alone or as an integrated piece of a specialized interface that is presented within the context of a user initiated inbound (as is best in FIG. 4) or as a system initiated outbound (as is best shown in FIG. 5) call interaction. When the main menu is called by the voice enabled system, the user is presented with a series of dynamic prompts 210, the exact nature and number of which are determined by the particular profile of the user. If the user profile contains at least one of the auction items that is appropriate to one of those specific prompts 210, then that prompt is read as an option in the main menu. If the user's profile does not contain the particular auction item, then the prompt is not provided as an option in the main menu. Thus, it will be appreciated that the main menu will be relatively simple while still allowing a user all the possible options for auction participation that are usual and appropriate.

A list of the auction prompts available from the dynamic menu prompts 210 will now be described. By way of a first example, an open bidding auctions prompt 211 is provided such that if there are open auctions in which the user has placed a bid, a prompt will give the user the option to browse each auction to identify any such auction in which additional action might be taken. That is, the user may not have placed the current high bid and may wish to raise his bid following receipt of the prompt 211.

A closed won auctions prompt 212 is provided in the event that there are recently closed auctions in which the user has placed the winning bid. Prompt 212 gives the user the option to browse those auctions for any auction in which the user would like to consider taking additional action. The conditions that result in the classification of a recently closed auction is preferably user configurable and will often have a default value in a predetermined number of days that are appropriate to the subject of the auction.

An open watching auctions prompt 213 is provided if there are any open auctions that the user has selected to be actively monitored by the auction system. Prompt 213 gives the user the option to browse those auctions for any auction in which the user would like to take additional action. The user may or may not have placed a bid in this auction in order for the prompt 213 to be made available.

An open selling auctions prompt 214 is provided if there are any open auctions in which the user is the seller. Prompt 214 gives the user the option to browse those auctions for any auction in which the user would like to consider taking additional action.

A closed sold auctions prompt 215 is provided if there are any recently closed auctions in which the user is the seller and a successful bid was placed. Prompt 215 would give the user the option to browse those auctions for any auction in which the user would like to consider taking additional action.

A closed no sale auctions prompt 216 is provided if there are any closed auctions in which the user is the seller and no successful bids were placed. Prompt 216 gives the user the option to browse those auctions for any auction in which the user would like to consider taking additional action.

If the user selects one of the dynamic menu prompts 210 during a selection step 220, then the user is presented with a choice of auction objects within the selected category. If the user does not select one of the options offered by the prompts during the selection step 220, the interactive auction system returns to the context that called the main menu to handle the original user input.

In the case where a selection is made by the user during step 220, one of a variety of corresponding options are available. By way of an open bidding auctions process 231, the user is provided with a brief list of open auctions in which the user has placed a bid. The user may select one of these auctions and the interactive auction system then reads the relevant information, such as the auction number, title, current price, time remaining and item description. If desired, the user may choose a first action in order to place a new bid or raise a current bid. The user may also choose another action such as contacting the seller. Once the action has been selected, the iriteractive auction system confirms that the action was completed correctly and then returns to the context that called the main menu.

Another option that is available to the user is a closed won auctions process 232. If this option is selected, the user is provided with a brief list of recently closed auctions in which the user has placed a winning bid. The user may select one of these auctions, and the interactive auction system then reads the relevant information such as auction number, title, winning bid and description. If desired, the user may choose a primary action for this auction category such as contacting the seller to request a total price (including shipping), or a second action such as leaving feedback for the seller. Once the action has been selected, the interactive auction system confirms that the action was successfully completed and then returns to the context that called the main menu.

Another option available to the user is an open watching auction process 233. If this option is selected, the user is provided with a brief list of open auctions that the user has selected for active monitoring by the auction system. The user may select one of these auctions, and the interactive auction system then reads the relevant information, such as auction number, title, current price, time remaining and description. If desired, the user may choose a primary action for this auction category, such as placing a new bid or raising the current bid, or a secondary auction, such as contacting the seller. Once the action has been selected, the interactive auction system confirms that the action was successfully completed and returns to the context that called the main menu.

Yet another option available to the user is an open selling auctions process 234. If this option is selected, the user is provided with a brief list of open auctions in which the user is the seller. The user may select one of these auctions, and the interactive auction system then reads the relevant information such as the auction number, title, current price, high bidder identity, time remaining and description. If desired, the user may choose a primary action for this auction category, such as upgrading the auction listing to obtain special featured placement or promotion, or a secondary action, such as contacting the current high bidder. Once the action has been selected, the interactive auction system confirms that the action was successfuilly completed and then returns to the context that called the main menu.

Another option available to the user is a closed sold auctions process 235. If selected, this process provides the user with a brief list of recently closed auctions in which the user is the seller and a successful bid was placed. The user may select one of these auctions, and the interactive auction system then reads the relevant information, such as auction number, title, winning price, high bidder identify, and description. If desired, the user may choose a primary action for this auction category, such as contacting the buyer to request a shipping address, or a secondary action, such as leaving buyer feedback. Once the action has been selected, the interactive auction system confirms that the action was successfully completed and then returns to the context that called the main menu.

Another option that is available to the user is a closed no sale auctions process 236. If this option is selected, the user is provided with a brief list of recently closed auctions in which the user is the seller and no successful bids were placed. The user may select one of these auctions and the interactive auction system then reads the relevant information, such as the auction number, title, starting price, unsuccessful bidder identity, and description. If desired, the user may choose a primary auction for this auction category, such as relisting the auction for sale on the auction service, or a secondary action, such as contacting an unsuccessful high bidder. Once the action has been selected, the interactive auction system confirms that the action was successfully completed and then returns to the context that called the main menu.

After the user interaction with the main menu of FIG. 2 has been completed, or if one of the available auction interaction categories or main menu items is not selected, the interactive auction system returns to the context that originally called these options during step 240.

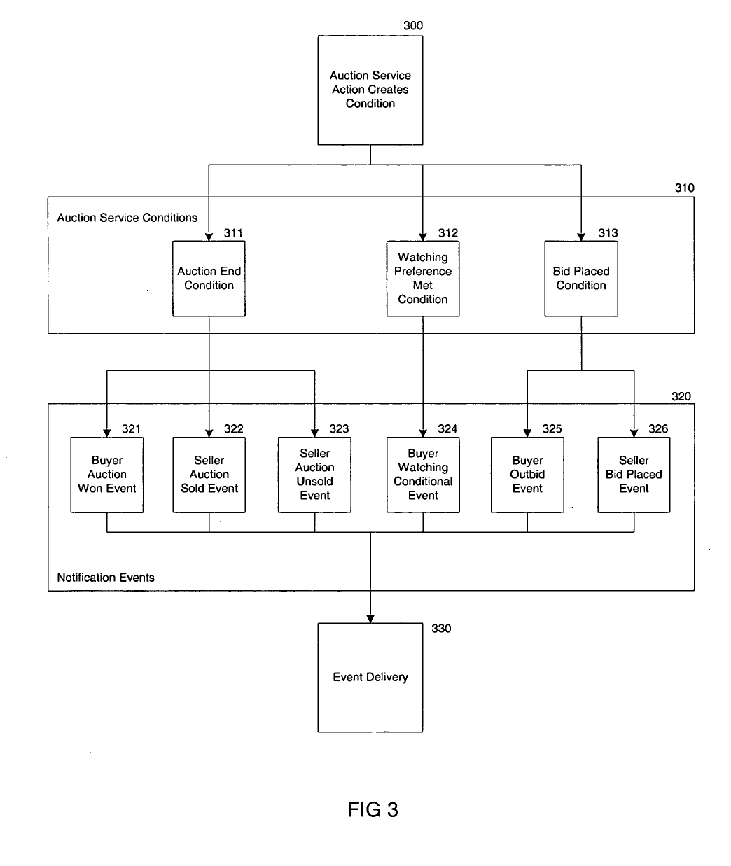

Turning to FIG. 3 of the drawings, there is shown a diagram to illustrate examples of automated auction system actions that create conditions which trigger notification events. The event types to be described below are specific to the finctional specifications of the auction service (designated 141 in FIG. 1) as determined by the auction service implementation requirements. Initially, an action is performed by the auction service 141 of the on-line auction system 140. Such an auction service action, whether user generated, time based, or created by another condition, results in the fulfillment of a condition during step 300 of FIG. 3 that may effect other users of the auction system.

The following is a list of exemplary auction service conditions 310 that depend upon an auction service action that may have ramifications for other users of the auction system. One such condition is an auction end condition 311 which is relevant when the auction ends. The auction end condition 311 will effect those users participating in auctions of the auction service regardless of whether such users are bidders or sellers.

Another condition that is based on an auction service action is a watching preference met condition 312. In this case, a user may select particular auctions for active monitoring by the auction service. If an auction reaches a level that meets the defined conditions set by a user, it may be relevant to that user to enable timely interaction to be completed. Such defined conditions may include the current high bid, auction time remaining, and other variables that are appropriate to the auction process.

Still another condition that is based on an auction service action is a bid placed condition 313. When a new bid is placed in an auction, the magnitude of the new bid may be relevant to those users who are participating in an auction, whether the users are bidders or sellers.

As a result of the fulfillment of some of the auction service conditions 310, notifications 320 may be generated to users for which the auction condition has particular relevancy. The following is a list of possible notifications 320 that are sent to participants of an auction, whether they are bidders or sellers. A first notification 321 is generated for a buyer auction won event. At the conclusion of an auction, the winning bidder may wish to be notified in order to confirm his purchase and initiate the fulfillment process.

Another notification 322 is generated for a seller auction sold event. When an auction ends with a successful bid, the seller may wish to be notified in order to confirm the final price and initiate the fulfillment process.

Another notification 323 is generated for a seller auction unsold event 323. When an auction terminates without a successful bid, the seller may wish to be notified in order to relist the item for sale in another auction.

Yet another notification 324 is generated for a buyer watching conditional event. A user may define certain conditions and then wish to be notified when such conditions are met. Such conditions may include high bid price, time remaining, or other variables that are appropriate to the auction process, whereby the user may still act to place a bid for a particular auction that is still available on the auction service.

Still another notification 325 is generated for a buyer outbid event. When a bid is placed that is higher than the existing high bid, the user who placed the previous high bid may desire to be notified in order to learn that he has been outbid so that he will have an opportunity to enter his own new high bid for an item.

An additional notification 326 is generated for a seller bid placed event. When a bid is placed that is higher than the previous high bid, the seller of the item may wish to be notified in order to learn the current high bid for his auction listing.

Once a notification event 320 is generated, it is delivered during step 330 according to the system and user defined settings that regulate the conditions under which delivery is appropriate.

FIG. 4 of the drawings illustrates the process flow where an auction member calls the voice enabled interactive auction system of FIG. 1 for the purpose of obtaining auction object information and/or participating in an auction related to an auction object. The process of an inbound user initiated interaction 400 occurs when a call is connected from the user 100. That is, the user dials the application access phone number and the call connects via the telephony network 110 of FIG. 1. Following user connection, user login 410 occurs during which the user is greeted by a suitable welcome message that may include an optional sponsor message as well as a prompt to enter the login ID of the user for the purpose of identification. User identification may also be accomplished through a user or caller ID or any other unique identification means, whether automated or manual. Once identified, the user must then enter a personal PIN security identifier that confirms the user's permission to access his auction account. The PIN, or password, step may be eliminated depending upon the security preferences of the user.

Following the user login 410, a series of automated logical steps occur by means of dynamic prompts logic 420. These steps lie in the background to determine the number of active auction events that are in the auction account of the user. Active auction events are auction service conditions that fulfill criteria to make them of timely interest to the user. Such active auction events are the same conditions that enable navigation options in the main menu (of FIG. 2). However, this mechanism provides the user with links directly to the auctions that are most appropriate to the user's immediate interests. If the user has no active auction events, he is directed to the main menu for navigation through the auction service options. If the user has only one active auction event, he is provided with a prompt to jump directly to that auction without having to listen to all of the available options of the main menu. If there is more than one active auction event, then the user is taken to a dynamic list of auction events 1 . . . N.

Following the dynamic prompts logic 420 are dynamic auction event prompts 430. A user is read a list of events which are active auction events in the user's auction account and from which the user can select one event for immediate access to the auction without having to listen to all of the available options in the main menu. Once the dynamic list of auction events has been completed, the user is taken to the main menu for other navigational options.

The next step of the inbound process flow is the auction item selection step 440. An auction item is selected via either one of a dynamic prompt for an active auction event or through the main menu of FIG. 2. During this step, the user selects a particular auction for information and potential action.

During an auction item step 450, and as was previously described when referring to FIG. 2, the user first evaluates relevant information for the auction item selected during the prior step 440 and then elects whether further action is required for the selected item. If an election is made to participate, an input is completed and the system provides a message to confirm that action has been initiated and executed.

Following confirmation that an action was consummated, the user may elect to end the call at step 460 or return to the application in order to select another auction item for interaction, either through the dynamic active auction event prompts 430 or the main menu of FIG. 2. Should the user choose to end his call, the system simply disconnects the incoming line at step 470.

FIG. 5 of the drawings illustrates the process flow of the voice enabled automated auction system for transmitting an auction event or events to the telephony device (designated 101, 102 and 103 in FIG. 1) of a user for the purpose of delivering auction information and/or enabling a user action relating to an auction object. The user telephony device receives a call from the interactive auction system at step 500. Next, the user decides whether to accept the call during step 510. If the user accepts the call, he enters the interactive auction system and then may receive an optional sponsor message. If the call is not accepted, then the interactive auction system may respond in any one of a variety of actions.

A first action 511 will occur when the telephone line is busy. If the line is busy, predetermined business rules that are appropriate for an auction determine whether the call is repeated or simply abandoned. Such business rules typically have a default condition but may also be configured by the user.

A second action 512 will occur if the telephone line is answered by a voicemail system. In this case, the business rules determine whether a message is left, the call is repeated, or the call is simply abandoned. Such business rules have a default condition but may also be configured by the user.

Another action 513 will occur if the telephone line is answered by a facsimile tone. In this case, the business rules determine whether a fax is transmitted with relevant auction information, the call is repeated, or the call is simply abandoned. Such business rules have a default condition but may also be configured by the user.

An additional action 514 will occur when the line is connected but dropped prior to login. Once again, the business rules determine whether the call is repeated or the call is abandoned. Such business rules have a default conditions but may also be configured by the user.

Provided that the user accepts the call from the application, he is prompted with a brief list of active auction events 520 that triggered the outbound interaction between the interactive auction system and the user. This list provides a brief summary of each auction event so that the user may decide whether the event is worthy of entering the interactive auction system for more information and potential actions. The list is kept relatively short for the purpose of speedy evaluation as well as security and privacy, since this information is provided to the user prior to a secure login to the on-line auction system.

Once the user is alerted to an auction event that merits his evaluation and potential action, he initiates a login process at step 521. Since the telephone call was made to a potentially secure telephone device, the user may elect to configure his account to require the entry of a secure PIN, or the user may set-up an account to enter the on-line auction system directly. This setting may be user configurable or selected to accommodate standard auction service security policies. Following login, the user may be presented with an optional sponsor branding message.

After the user enters the interactive auction system, dynamic prompt logic 530 causes a series of automated logic steps to occur in the background to determine the number of active auction events that are in the auction account of the user. Active auction events are auction service conditions that fuilfill criteria to make them of timely interest to the user. These events are the same conditions that enable navigation options in the main menu. However, the dynamic prompt logic 530 provides the user with links directly to the auctions that are most appropriate for the user's immediate attention.

In the event that the user has no active auction events, he is taken directly to the main menu for navigation through the auction service options. If the user has only one auction event, he is provided with a prompt to jump directly to that auction without having to listen to all of the available options of the main menu. If there is more than one active auction event, then the user is taken to a dynamic list 540 of auction events 1 . . . N.

More particularly, the user is prompted with a list 540 of auction events including a brief summary of the active auction events in his account from which the user can select one event for immediate action to the auction without having to listen to all of the available options in the main menu. Once the dynamic list of option events is completed, the user is taken to the main menu for other navigational options.

In the case where the user selects an auction item during step 550 via either a dynamic prompt for the list 540 of auction event or through the main menu, he selects a particular auction for information and potential action. During an auction item step 560, and as was previously described when referring to FIG. 2, the user first evaluates relevant information for the auction item selected during step 550 and then elects whether additional action is required. If some additional action is necessary, an input is completed and the system provides a message to confirm that action has been initiated and executed.

Following confirmation that an action was consummated, the user may elect to end the call at step 570 or return to the application in order to select another auction item for interaction, either through the dynamic list 540 of auction events or the main menu of FIG. 2. Should the user choose to end his call, the system simply disconnects the incoming line at step 580.

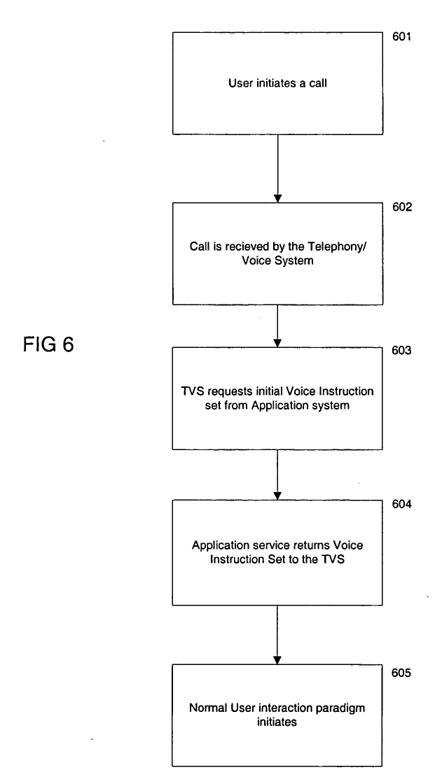

Turning to FIG. 6, there is shown a block diagram to illustrate the common data and control flow of a system inbound call initiation when a user calls the telephony/voice system 120 of FIG. 1. FIG. 6 demonstrates how the voice enabled automated on-line auction system herein described reacts to an inbound call placed by a user and how the interactive auction system eventually delivers the first pieces of interaction to the user. The steps which are indicative of the system inbound call interactions are described while referring concurrently to FIGS. 1 and 6 of the drawings.

A user 100 uses his telephone device 101, 102 or 103 to initiate a telephone call across any telephony network 110 of FIG. 1. The incoming telephone call is made during step 601 of FIG. 6 and received by the telephony/voice system 120 of FIG. 1 during step 602 of FIG. 6. The call is then -accepted by the telephony/voice system 120.

During step 603 of FIG. 6, the telephony/voice system 120 requests an initial voice instruction set from the application system 130 of FIG. 1. This initial instruction set can be prestored or retrieved at the time of the inbound call. The initial request can also include information derived from the telephony network 110 (e.g., caller ID) and/or the number that was dialed by the user (DNIS).

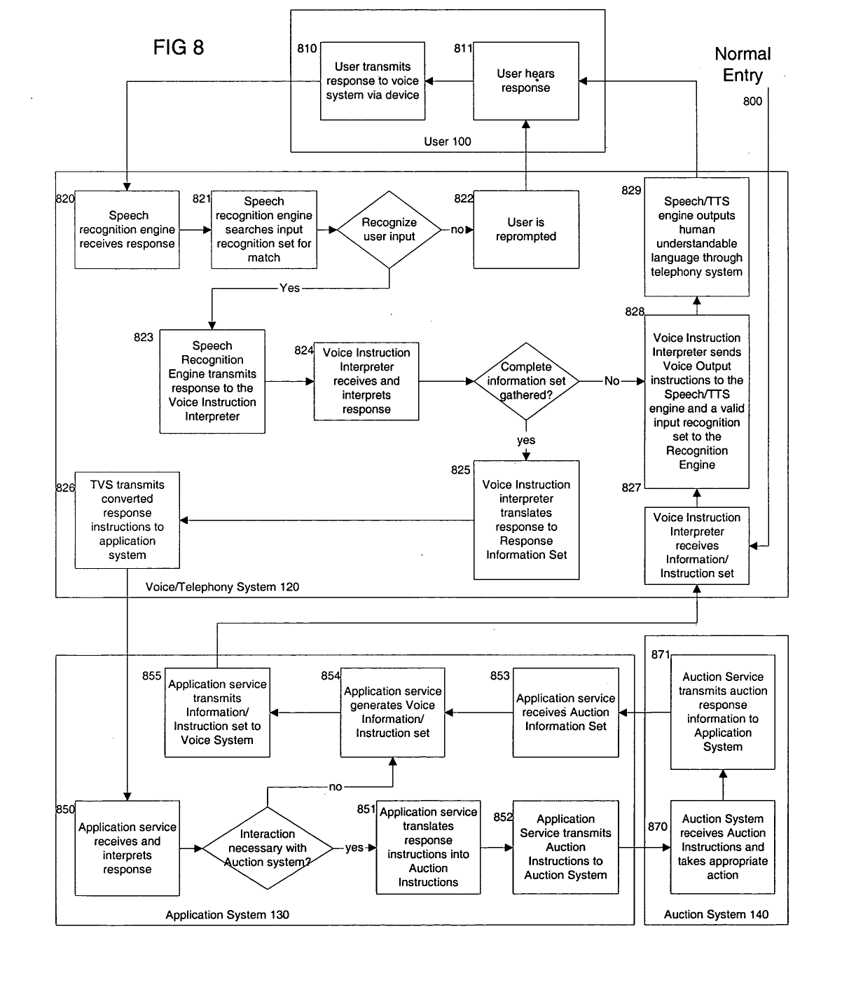

During step 604 of FIG. 6, the application service 131 of the application system 130 of FIG. 1 returns an initial voice instruction set to the telephony/voice system 120 which, in turn, is delivered to the voice instruction interpreter 123 thereof. By way of example only, the first instruction set may be a simple message (e.g., such as a welcoming message to the user 100) and does not require particular grammar. However, the returned instruction set from the telephony/voice system 120 could reflect information that was supplied by the telephony network 110. For example, if a caller ID was used, a specific welcome message could be presented to the user 100 that was associated with the user's phone number. Lastly, during step 605 of FIG. 6, the normal user-to-system interaction begins (see line 800 in FIG. 8).

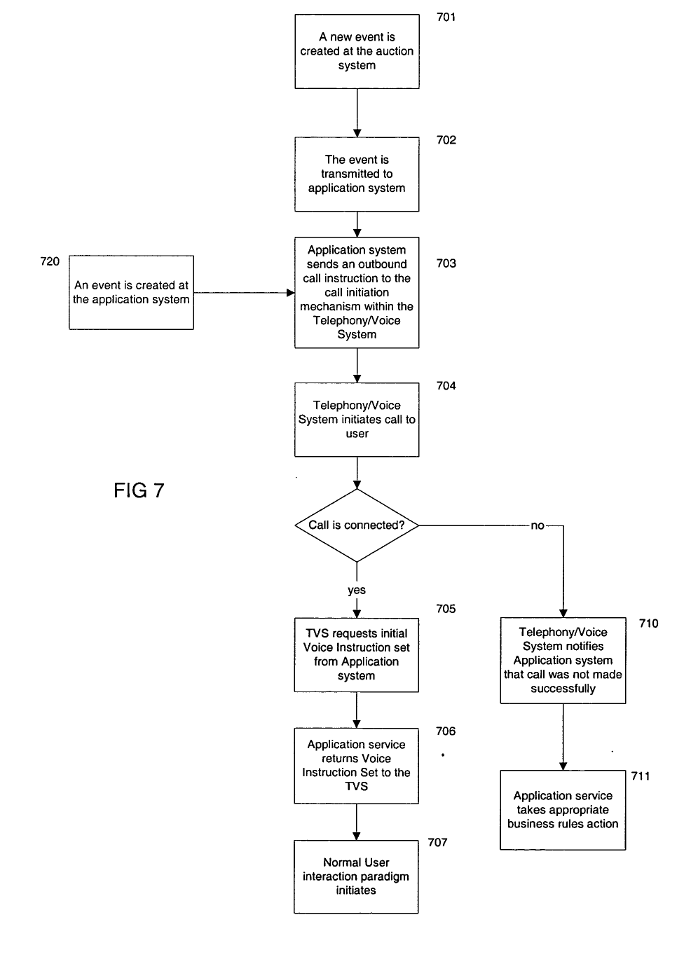

While FIG. 6 illustrates the common data and control flow of a system inbound call initiation, FIG. 7 of the drawings illustrates the common data and control flow of a system outbound call initiation. That is, FIG. 7 is a block diagram to illustrate the steps by which the voice enabled interactive auction system places an outbound call to a user, how the outbound call is initiated, how the system eventually delivers the first pieces of interaction to the user, and how the system reacts in the case of an unsuccessful outbound call. The steps which are indicative of the system outbound call initiation are described while referring concurrently to FIGS. 1 and 7 of the drawings.

During the initial step 701 of FIG. 7, the on-line auction system 140 of FIG. 1 creates an auction event which must be delivered to the user 100. This event is transmitted to the application system 130 of FIG. 1 during step 702 of FIG. 7. The event can be actively sent (i.e. pushed by the on-line auction system 140) or requested (i.e. pulled) by the application system 130. Any events transmitted should be considered as auction specific (e.g., a bid was placed, a user was outbid, an auction has terminated, etc.). The foregoing represents one method by which an event can be contained within the application system 130.

Alternatively, the application system 130 may contain an auction event when the application system 130 generates its own event. This event will be considered as non-auction specific (e.g., a timer has expired, an account is overdue, etc.). However, such events are still pertinent to the voice enabled interactive auction system of FIG. 1. Once an event is contained within the application system 130, a decision must be made how to handle such events. During step 703, and provided that a decision is made to place a call, the application service 131 within the application system 130 sends an outbound call instruction to the call initiation mechanism 124 within the telephony/voice system 120 of FIG. 1. This call instruction typically contains the telephone number to be called, instructions for the system in the case of a successfully placed call, and instructions for the system in case of an unsuccessfully placed call. It should be recognized that the application service 131 does not necessarily have to act immediately upon receiving an event. The business rules that are established and in place at the time of the auction will determine the actions to be taken in view of particular events given a particular state of conditions. Inasmuch as FIG. 7 relates only to outbound call initiation, a detailed discussion of the timeliness of the actions taken by application service 131 has been omitted. Nevertheless, and by way of example only, the application service 131 would typically store an event to be handled later or deleted (e.g., if a user instructed the system not to call between certain hours of the day or if a user were no longer active within the system).

During step 704 of FIG. 7, the telephony/voice system 120 initiates a call to the user 100. Upon receiving the outbound call instruction, the telephony/voice system 120 will place an outbound call to the user. Such outbound call would be accomplished over the telephony network 110. The call will either be completed successfully to the user or, for a variety of reasons, the call will be unsuccessful. In the event that the call to the user is successful, the telephony/voice system 120 requests an initial voice instruction set from the application system 130 during step 705 of FIG. 7. The initial instruction set can be prestored or retrieved at the time of the inbound call. The initial request can also include information derived from the telephony network 110 such as the caller ID or the number that was dialed (DNIS). Information will also be sent back to the application system 130 regarding the identity of the caller (i.e., whereby to return information that was originally supplied by the application system 130).

Provided that the outbound call was successful, the application service 131 of application system 130 of FIG. 1 returns the instruction set to the telephony/voice system 120 during step 706 of FIG. 7. The application service 131 within the application system 130 returns an initial voice instruction set to the telephony/voice system 120 which is delivered to the voice instruction interpreter 123 thereof. This instruction set can be more detailed than the example described when referring to step 604 of FIG. 6, inasmuch as the application service 131 should now be aware of the identity of the user being called and the reason for the call. During step 707, normal user interaction begins. That is, the normal user-to-system interaction occurs (see line 800 of FIG. 8).

In the event, however, that the outbound call that was placed during step 704 of FIG. 7 was unsuccessful, then, during step 710, the telephony/voice system 120 notifies the application system 130 that the outbound call was not successfully completed. The telephony/voice system 120 should be capable of relaying back to the application system 130 the reasons for unsuccessful outbound calls in cases where it is desirable to create a robust and intelligent interactive auction system. By way of example, an outbound call may be unsuccessful in the event that the telephone of the user is busy, the telephone number of the user is invalid, the user was not available to access his telephone, the telephony network 110 was busy, etc.

Finally, during step 711 of FIG. 7, the application service 131 of application system 130 takes appropriate action according to the business rules in place during the auction. That is, upon notification that a call was not successfully completed to the user, the application service 131 will respond in a manner that is determined by the existing business rules. By way of example, the application service 131 of application system 130 may instruct the telephony/voice system 120 to try a new call to the user, to simply discard the event that initiated the outbound call, store the event that initiated the outbound call to be tried again in the future, notify the auction system, etc.

FIG. 8 of the drawings illustrates the normal cycle by which a user 100 interacts with the voice enabled interactive auction system that has been heretofor described while referring to FIGS. 1-7. The user interaction cycle is typically initiated when the user calls the auction system or when the system calls the user. Once a call is enabled, the interaction cycle will repeat until the call has been terminated. It should be recognized that a call can end for a variety of reasons (e.g., such as where the user hangs up). In the alternative, the voice/telephony system 120 is also capable of terminating a call at any time. Additional processing and system interaction may continue after a call is terminated. For example, if the user hangs up, the voice/telephony system 120 may choose to notify the application system 130 of a hang up condition, and the application service (designated 131 in FIG. 1) of the application system 130 may choose to make a record that the user has terminated the call at a specific time. For purposes of simplicity, such processing and system interaction after a call has been terminated will not be described when referring to FIG. 8. Therefore, FIG. 8 is provided only to illustrate the normal user-to-system interaction cycle that is associated with the voice enabled interactive auction system shown in FIG. 1.

During normal entry 800, it is assumed that an inbound or outbound call has already been connected (as previously described when referring to FIGS. 6 and 7), that the application system 130 is aware of the connected call, and that the application system 130 has delivered an appropriate instruction set to the voice/telephony system 120. The voice instruction interpreter 123 of the telephony/voice system 120 of FIG. 1 receives an information/instruction set during step 827 for further processing. During step 828, the voice instruction interpreter 123 processes the voice information/instruction set that has been delivered by the application service 131 of the application system 130 of FIG. 1 and distributes voice output instructions to the speech/text-to- speech engine 121 of the telephony/voice system 120. At the same time, a valid input recognition set is sent to the speech/DTMF recognition engine 122 of telephony/voice system 120.

The output instructions and recognition set are typically in the form of text (for use by the speech/text-to-speech engine 121) or text and numbers (for use by the speech-DTMF recognition engine 122). For example, it may also be necessary to send pronunciation instructions to the speech/text-to-speech engine 121 or to the speech/DTMF recognition engine 122. In addition, the output instructions and recognition set can be further encoded by a propriety scheme. Moreover, it is also possible for either of the output instructions or input set to be empty. In the case of an empty recognition set, the system will typically wait for any user input, or the telephony/voice system 120 will simply continue to operate after the speech/text-to-speech engine 121 has finished delivering its output. In the case of empty output instructions, the system will simply not deliver any content to the user and will expect the user to understand what to enter without any prompting. In this same regard, it should be understood that the voice information/instruction set should also contain instructions for taking action once a particular input has been derived. As the telephony/voice system 120 must typically interact only with the application system 130, the instructed response from system 120 should be in a form that will be understood by application system 130.

During step 829, the speech/text-to-speech engine 121 of telephony/voice system 120 sends output to the telephony network 110 to be ultimately delivered to the user 100. However, the speech/text-to-speech engine 121 should have the capability of delivering other forms of prompting that will be understood by the user. For example, the engine 121 should be able to deliver prerecorded audio, DTMF, etc.

During step 811, audio is transmitted from the telephony/voice system 120, through the telephony network 110, for receipt at the user's telephone device 101, 102 or 103 to be heard by the user 100. Next, at step 810, the user responds to the audio message he hears. That is, after being prompted (if there is a prompt available to the user), the user 100 responds accordingly. In this case, the user may either speak his response or press appropriate audio tone keys on his telephone device (DTMF).

The speech/DTMF recognition engine 122 of the telephony/voice system 120 of FIG. 1 receives the user's response at step 820 of FIG. 8. The response of the user is transferred over the telephony network 110 back to the telephony/voice system 120 where it is then delivered to the speech/DTMF recognition engine 122. At step 821, the recognition engine 122 searches its input recognition set for a match. Recognition engine 122 can take different actions depending upon whether a match has been made.

In the case of an unsuccessful match between the response of the user and the input recognition set of the recognition engine 122, then the user is reprompted during step 822. For example, voice/telephone system 120 will typically reprompt the user if the user was not heard or understood. However, the system should also be capable of taking other actions. For example, system 120 could simply report to the application system 130 that no match was found.

If, however, there was a successful match between the response of the user and the input recognition set of the recognition engine 122, then the recognition engine transmits a response to the voice instruction interpreter 123 of the telephony/voice system 120 of FIG. 1 during step 823. The speech/DTMF recognition engine 122 will typically notify the voice instruction interpreter 123 of a successful match and deliver the input that has been recognized. Although it is not required, the recognition engine 122 should preferably be capable of delivering meta data that is associated with the user's response. For example, the recognition engine 122 could deliver a confidence level in the match, a recording of the user's input, etc.

Provided that there was a successfuil match, the voice instruction interpreter 123 will receive and interpret the response from speech/DTMF recognition engine during step 824. In this case, the voice instruction interpreter 123 must evaluate the response and then decide on the next action to be taken. Typically, the decision to be made by the voice instruction interpreter 123 is relatively simple and is dependent upon whether the voice instruction interpreter 123 has accumulated a complete information set that is based on the original instruction set it was provided during step 828. However, the voice instruction interpreter 123 may make several complicated calculations. Such calculations could be based on the confidence level returned by the speech/DTMF recognition engine 122, how long the user took to respond, etc. The level of detail of the calculations made by voice instruction interpreter 123 is not necessary to an understanding of this invention and will not be described in FIG. 8.

If the instruction set that is required has not been sufficiently fulfilled, then the voice instruction interpreter 123 will send further output instructions and input sets to the appropriate components of the interactive auction system (see prior step 828). Such further instructions would typically be sent when the original information/instruction set that was supplied to voice instruction interpreter 123 was either large or multi-leveled or could not be fulfilled with a single round of interaction with the user 100.

On the other hand, if a complete information set is accumulated, then the voice instruction interpreter 123 of telephony/voice system 120 translates the response during step 825. That is, depending upon the input from the speech/DTMF recognition engine 122 and the original instruction set, the voice instruction interpreter 123 builds a response information set. This response information set typically represents the interpreted input of the user 100 as well as the action to take with the input set. For example, depending upon the user's input, the voice instruction interpreter 123 could be directed to deliver the input to different places within the voice enabled auction system. This information set can also contain additional information such as a recording of what the system heard, a confidence level, etc.

The telephony/voice system 120 transmits the converted response information set to the application system 130 during step 826. The response instruction set transmitted to application system 130 can take any suitable form that is determined by the contract between voice/telephony system 120 and application system 130 (e.g., XML could be passed, a remote procedure call could be made, an http post could be sent, etc.). However, the precise method or format by which the intended information is passed will not be explained in FIG. 8.

Next, the application service 131 of application system 130 receives and interprets the response from the voice/telephony system 120 during step 850. After receiving a response, the application service 131 will typically fulfill a predetermined business rules action (e.g., to record a user action, send a bid request to the auction system 140, etc.). However, the precise level of detail of the business rules action to be completed by application service 131 will not be described in FIG. 8.

After processing the response from the voice/telephony system 120, the application system 130 must determine if interaction will be required with the auction system 140. In the event that interaction between application system 130 and auction system 140 is not necessary, then the application service 131 of application system 130 generates a voice/information instruction set during step 854. In general, even if no interaction is necessary with the auction system 140, the application service 131 will always generate a return instruction set for the telephony/voice system 120 (except in the case where the telephony/voice system 120 has notified the application system 130 that the user has hung up and terminated the call). Otherwise, the user would be left hanging indefinitely while awaiting a further communication from the interactive auction system. If interaction between application service 130 and auction system 140 is not necessary, the generated information/instruction set will typically contain additional menu navigation or prompting to gain further information from the user. However, in the case where interaction is required, the information/instruction set will typically contain a transaction of the response from the auction system 140 and corresponding prompting and instructions for subsequent actions to be taken. Provided that interaction with the auction system 140 is not required, then the application service 131 of application system 130 will now transmit the information/instruction set to the voice/telephony system 120 for further processing and user interaction during step 855.

In the event that interaction is otherwise required between the application system 130 and the auction system 140 of FIG. 1 during step 850, then the application service 131 of application system 130 translates the response instructions into action instructions during step 851. When enough information has been accumulated to warrant an interaction with the auction system 140, the application system 130 generates auction instructions. It should be recognized that the instructions generated by the application system 130 do not necessarily need to reflect directly upon the response instructions of the voice/telephony system 120. For example, due to predetermined business rules, the application system 130 can, at any time, request a refresh of the profile of a user from the auction system 140.

Next, during step 852, the application service 131 of application system 130 transmits the auction instructions to the auction system 140. These instructions can be in any suitable form that is determined by the contract between the application system 130 and the auction system 140 (e.g., XML could be passed, a remote procedure call could be made, an http post could be sent, etc.). However, the precise method or format by which the intended information is transmitted will not be explained in FIG. 8.

During the next step 870, the auction system 140 receives the auction instructions from the application service 131 of application system 130. After receiving the auction instructions, the auction service 141 of auction system 140 will follow its predetermined business rules and take appropriate internal action. For purposes of simplicity, it is assumed that a request/response relationship exists between the application system 130 and the auction system 140. Accordingly, a portion of the responsibility of auction system 140 during this interaction will also be to generate an auction response information set.

In this case, the auction system 140 transmits the auction response information set to the application system 130 during step 871. This transmission from auction system 140 can be in any suitable form as determined by the contact between application system 130 and auction system 140 (see step 852).

Finally, during step 853, the application service 131 of application system 130 receives the auction response information set. The application service 131 may need to perform additional tasks prior to generating a response to the user 100. However, the precise nature of such additional tasks will not be described in of FIG. 8.

It is to be understood that the voice enabled interactive on-line auction system herein described is capable of receiving and transmitting dynamically generated content concerning on-line auction events in different forms including, but not limited to, XHTML, HTML, SMIL, WML, XML, VXML, SALT, SOAP, JavaScript, CSS, SVG, SyncML, ECMAScript, Java, WAV, and MP3 and converting such content into interactive voice responses. Communication between the user's telephone device (e.g., 101, 102 or 103) and the telephony network 110 to permit interaction between the user and the telephony/voice system 120 may use internet protocol (IP), wireless application protocol (WAP), voice over IP (Voip), or any other suitable protocol.

1. An interactive system by which to convert auction specific information relating to auction events, content and object data generated by an on-line auction system into interactive voice communications for transmission to a user, said interactive system comprising:
an application system to receive the auction specific information generated by the on-line auction system and to convert said auction specific information into voice content and instructions;
a telephony/voice system to receive the voice content and instructions produced by said application system and to generate an interactive voice response to said voice content and instructions;
a telecommunications network by which to transmit the interactive voice response generated by said telephony to the user; and
a telephone at which the user receives the interactive voice response transmitted by said telecommunications network.

2. The interactive system recited in claim 1, wherein said telecommunications network is one of a cellular telephone network, a mobile telephone network, a satellite telephone network, or a public switched telephone network.

3. The interactive system recited in claim 1, wherein said telephone of the user is one of a mobile telephone, a cellular telephone, a terrestrial telephone, or a satellite telephone.

4. The interactive system recited in claim 1, wherein said telephony/voice system has means communicating with said application system by which to receive an outbound call instruction and thereby initiate an outbound call to the telephone of the user by way of said telecommunications network, said telephony/voice system also having means by which to accept an inbound call from the telephone of the user by way of said telecommunications network.

5. The interactive system recited in claim 4, wherein the means of said telephony/voice system to accept an inbound call from the telephone of the user is responsive to at least one of the voice of the user or audio tones (DTMF) generated by the user on the telephone of the user.

6. The interactive system recited in claim 5, wherein the means of said telephony/voice system to accept an inbound call that is responsive to at least one of the voice of the user or the audio tones generated on the telephone of the user is a speech/DTMF recognition engine that is adapted to convert the user's voice and the audio tones into corresponding voice/DTMF commands.

7. The interactive system recited in claim 6, wherein said telephony/voice system also includes a voice instruction interpreter interconnected with said speech/DTMF engine and said application system so as to receive said voice/DTMF commands and to provide to said application system corresponding response instructions to be delivered from said application system to the on-line auction system as auction instructions.

8. The interactive system recited in claim 7, wherein said telephony/voice system also includes a speech/text-to-speech engine interconnected with said voice instruction interpreter, said voice instruction interpreter receiving the voice content and instructions produced by said application system and generating voice output instructions in response thereto, said speech/text-to-speech engine receiving said voice output instructions and transmitting to said telecommunications network understandable human speech that is based on said voice output instructions generated by said voice instruction interpreter.

9. The interactive system recited in claim 7, wherein said application system includes an application service that is adapted to convert the response instructions provided by the voice instruction interpreter of said telephony/voice system into auction instructions to be delivered to the on-line auction system.

10. The interactive system recited in claim 9, wherein the application service of said application system generates said outbound call instruction to said telephony/voice system to initiate the outbound call to the telephone of the user, whereby to cause the auction specific information from the on-line auction system to be transmitted to the user as understandable human speech.

11. The interactive system recited in claim 9, wherein said application system also includes an application database communicating with said application service to store information from and receive information for said application service.

12. The interactive system recited in claim 1, wherein the auction specific information received by said application system and converted to voice content and instructions includes at least some of a description of auction items, a user profile containing auction items, auction events, auction status, and advertising related events.

13. An interactive system by which to convert on-line auction event information corresponding to auction events, content and object data into understandable human speech to be presented to a user and to convert speech and/or DTMF audio generated by the user into auction commands to be routed to an on-line auction in response to the auction event information, said interactive system comprising:
means to receive the auction event information from the on-line auction;
means to convert the auction event information into interactive responses as understandable human speech to be presented to the user;
a telephony network to deliver said interactive responses to the user; and
means communicating with said telephony network for converting the speech and/or DTMF audio response generated by the user into the auction commands to be routed to the on- line auction.

14. The interactive system recited in claim 13, wherein the means to convert the auction event information into interactive responses as understandable human speech to be presented to the user is a speech/text-to-speech engine.

15. The interactive system recited in claim 14, wherein the means to convert the auction event information into interactive responses also includes a voice instruction interpreter communicating with said speech/text-to-speech engine to provide voice output instructions to said speech/text-to-speech engine corresponding to the auction event information received from the on-line auction.

16. The interactive system recited in claim 15, wherein said means communicating with said telephony network for converting the speech and/or DTMF audio responses generated by the user into auction commands includes a speech/DTMF recognition engine communicating with said voice instruction interpreter so as to provide to said voice instruction interpreter voice/DTMF commands corresponding to said speech and/or DTMF audio responses generated by the user, said voice instruction interpreter providing output information in response to said voice/DTMF commands to be routed to the on-line auction as auction commands.

17. The interactive system recited in claim 13, further comprising call initiation means adapted to receive outbound call instructions and thereby initiate a call to the user by way of said telephony network so that the auction event information can be transmitted to the user.

18. A method for converting auction specific information relating to at least some of auction events, content and object data into interactive voice responses to be delivered to a user, said method comprising the steps of:
generating electronic data packets containing the auction specific information obtained from a source of said information at an on-line auction;
converting the data packets into corresponding voice content and instructions;
generating voice output instructions in response to said voice content and instructions;
generating an interactive voice response to said voice content and instructions as understandable human speech;
transmitting said interactive voice response to a telecommunications network; and
delivering said interactive voice response to the user by way of said telecommunications network.

19. The method recited in claim 18, including the additional steps of:
producing a user generated voice and/or audio (DTMF) signal in reply to said interactive voice response delivered to the user;
transmitting said user generated voice and/or audio signal from the user by way of said telecommunications network;
receiving and converting said user generated voice and/or audio signal into electronic auction instructions; and
routing said auction instructions to the on-line auction.

20. The method recited in claim 18, wherein the step of generating an interactive voice response to said voice content and instructions is accomplished by means of a voice instruction interpreter to receive said voice content and instructions and to provide corresponding voice output instructions, and a speech/text-to-speech engine communicating with said voice instruction interpreter to receive said voice output instructions and to provide said interactive voice response as understandable human speech.
